(19) United States
(12) Patent Application Publication
(10) Pub. No.: US 2006/0174199 A1
(43) Pub. Date: Aug. 3, 2006

(54) Web-based design system

(76) Inventors: Warren B. Soltis, Brentwood, TN (US); Sean P. McKelvie, Memphis, TN (US)

Correspondence Address: REED SMITH LLP, P.O. BOX 488, PITTSBURGH, PA, 15230-0488, US

(21) Appl. No.: 11/212,041

(22) Filed: Aug. 24, 2005

Related U.S. Application Data
(63) Continuation of application No. 09/714,422, filed on Nov. 16, 2000, now abandoned.

(51) Int. Cl. G06F 3/00; G06F 17/00

(52) U.S. Cl. 715/700

(57) ABSTRACT

A system and method for designing or customizing a product, web page, or other item, via a global computer network. The system includes a web server, a client computer, a PDF rendering engine, and a manufacturing computer. A user may select preliminary design choices form a web page at the client computer. After preliminary design choices are made, a web-based design editor allows customization of many different features of the designed product. The design editor may include drag & drop capabilities for repositioning design elements and preferably needs little or no client-server interaction during product customization. A PDF rendering engine generates a PDF file describing the designed invention, and the PDF may be used to directly drive manufacturing equipment to produce the product. The web-based design system may be especially useful in designing printed or graphical products such as business cards, stationary, and stamps.

### FIELD OF THE INVENTION

The present invention generally relates to systems and methods for customizing or designing a good, and more specifically relates to systems and methods for customizing goods including text and/or graphics using a design editor over a global computer network.

### BACKGROUND OF THE INVENTION

Traditional methods of selling goods involve a manufacturer deciding, usually based on customer preference, how and in what quantity goods are produced. However, for many goods, at least some amount of customization is desired by the consuming public. The essence of customizing a good includes the communication of design choices from a user to a manufacturer, and the production of the good by the manufacturer according to those design choices.

With the rise of networked computing and the increase in the number of Internet users, some manufacturers have attempted to provide customized goods over the Internet. Typically, a user will access these systems from their home or office using web browser software. The customizable product website may offer one or more choices with which a user can alter or customize one or more features of a desired product. The manufacturer may thereafter analyze these design choices and provide the chosen or customized product to the user, sometimes from pre-produced inventory.

These electronic purchasing systems typically do not provide the user with instantaneous feedback about their design choices. Also, these traditional sites allow only regimented and structured customization of a product according to manufacturer guidelines. Design elements cannot be freely relocated using simple drag & drop techniques. Improvements to the amount of product customization are always sought.

The communications between the manufacturing or distribution site and the user's computer are typically carried out using traditional client-server methodologies. For example, the server may send a web page including one or more selectable design features to the user's computer. An electronic indicator of the user's selection is typically sent back to the manufacturer or distributor's server. The server may perform some type of analysis on the indicator, and send a new or updated web page to the user's computer. This two-way communication after each feature of a customized product is designed or selected may extend the amount of time it takes for a user to custom design a product.

As such, a need has been recognized for systems and methods that enable a user to customize or custom-design a product in an efficient and intuitive manner. The system preferably includes functionality that enables a user to design a product without excessive client-server interaction. Such a design “editor” may be useful in a variety of different areas, including product design, web page design, and other areas.

### SUMMARY OF THE INVENTION

The present invention contemplates, in at least one preferred embodiment, a system and method for designing or customizing a product, web page, or other item. The invention may be part of an electronic design and manufacturing system that exists as part of a global computer network, such as the Internet.

In at least one embodiment, the present invention includes a web server, a client computer, a PDF (portable document format) rendering engine, and a manufacturing computer. The web server preferably provides one or more web pages to the client computer to enable the user to make general preliminary design choices about the custom-designed product. After preliminary design choices are made, the user is preferably presented with an electronic design editor that allows customization of many different features of the designed product. This design editor may include drag & drop capabilities and preferably needs little or no client-server interaction during product customization.

Name-value pairs of information describing the user-defined design choices may be sent directly or indirectly to the PDF rendering engine. This engine analyzes the name-value pairs of information to create a PDF file that describes the product to be designed. This product design may be presented to the user for approval, or may be sent to a manufacturing computer for product creation. The manufacturing computer and associated printers and other devices preferably use the PDF to directly create the desired product. For example, if a piece of stationary is designed, the manufacturing equipment may create appropriate printing plates and print the stationary.

The web server, PDF rendering engine, manufacturing computers, and other devices may be located remote from each other and connected via a computer network. Alternatively or additionally, one or more of these devices may be housed at the same location, or may even be part of the same computer or local network.

The design editor, rendering engine, and other devices may be especially useful in the design of a customized product such as business cards, stationary, and stamps. However, these devices could be used to design an almost endless assortment of products, web pages, and other items. These and other details, objects, and advantages of the present invention will be more readily apparent from the following description of the presently preferred embodiments.

### BRIEF DESCRIPTION OF THE DRAWINGS

The invention and its presently preferred embodiments will be better understood by reference to the detailed disclosure hereinafter and to the accompanying drawings, wherein:

FIG. 1 is block diagram of a web-based design system;

FIG. 2 is flow chart of one embodiment of a web-based design system;

FIG. 3 is a sample home page for a web-based design system;

FIG. 4 shows sample preliminary customization options;

FIG. 5 shows sample preliminary customization options; and

FIG. 6 shows a sample design editor page for editing the features of a business card.

### DETAILED DESCRIPTION OF THE PREFERRED EMBODIMENTS

The present invention broadly contemplates, in at least one preferred embodiment, a system and method for designing a customized product via a global computer network such as the Internet. The system preferably allows a user to design and edit a customizable product using a drag-and-drop design editor. The edited product results may then be sent to a PDF rendering engine that creates a PDF version of the designed product. This PDF file may be directly used with printing or manufacturing equipment to produce the desired product.

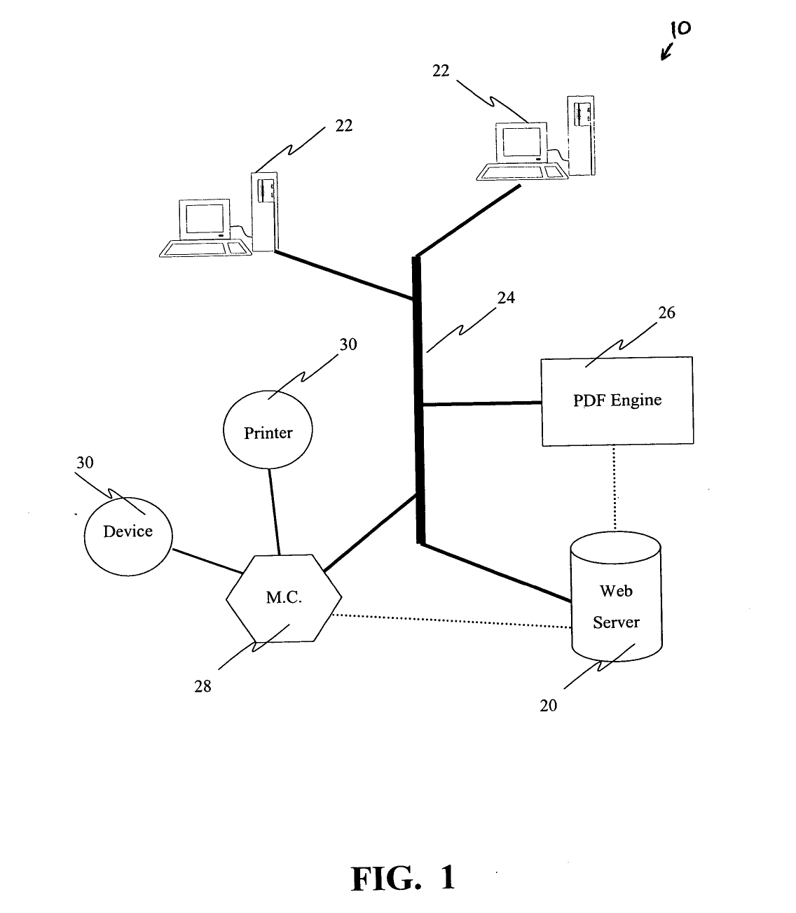

As depicted in FIG. 1, in at least one presently preferred embodiment of the invention, the web-based design system 10 includes a web server 20 for housing web-based information, a client computer 22 for accessing the web server 20 via a global or local computer network 24, a PDF rendering engine or computer 26 that converts a desired user design into a PDF file representation of the design, and a manufacturing computer 28 that runs a printer or other manufacturing equipment 30 to create a customer-desired product based on the PDF file.

All of the above entities 20, 22, 26, 28, 30 may be connected to each other over a global computer network 24, such as the Internet, and/or some of these entities could be housed in the same location or even be part of the same computer. For example, the PDF rendering computer 26 may be a part of the manufacturing computer 28 (or may be directly connected thereto), and both of these computers 26, 28 may exist in the same location as the web server 20. The client computer preferably exists remote from the other entities to maximize the number of users who can take advantage of the system.

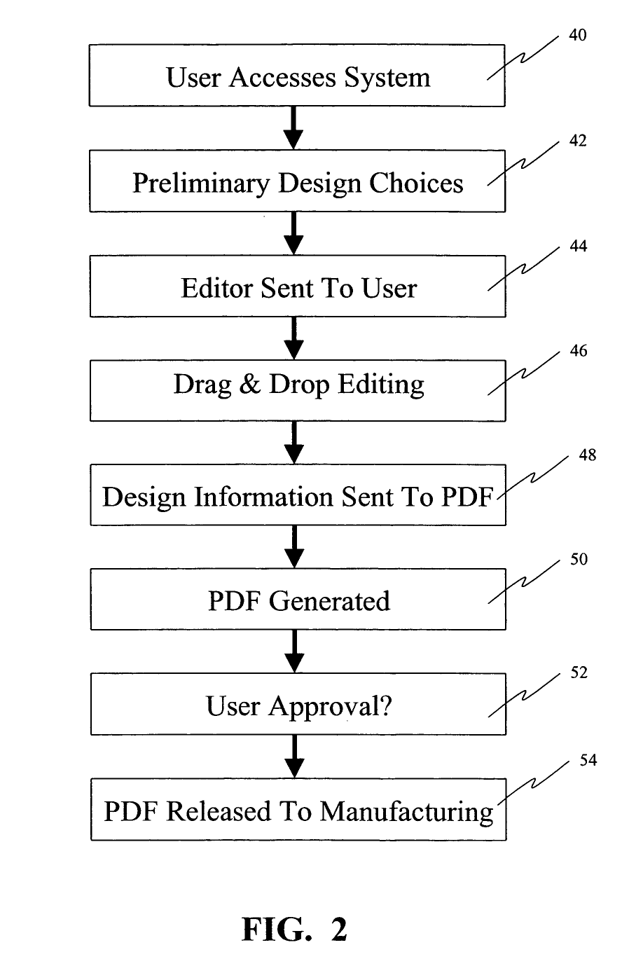

The system preferably operates as a series of discrete process steps as shown in FIG. 2. The user may initiate a custom product design session by accessing the product design website (block 40). After making several preliminary choices (block 42) about the desired product, the web server 20 (or other computer) preferably sends a complete design engine or DHTML editor (the “editor”) to the client computer 22 so that the user can use drag-and-drop functionality to edit their design (blocks 44, 46). Once the product has been edited to the user's satisfaction, the design information is preferably electronically sent to a PDF rendering engine or rendering computer 26 (block 48) that produces a PDF version of the product that accurately reflects the user's design (block 50).

The PDF may be sent back to the user for approval (block 52). Once approved, the PDF is preferably released to a manufacturing computer 28 and used to run the appropriate manufacturing or printing equipment 30 to produce the final product (block 54). This process may allow a user to design a custom product in a shorter amount of time and utilizing a lesser amount of network information transfers, as compared to conventional methods, to produce a good that more accurately recreates the user's design.

In one embodiment of the present invention, the system exists as a client-server system as part of a computer network. The user accesses 40 the system 10 using a personal computer or other device 22 from a location that may be remote from the web server 20. Preferably, the user can access the product design system 10 from his or her home, office, or other convenient place. The user may access the system 10 using a conventional web browser or some other computer program that allows the user to access and interact with web-based or HTML-based program code.

The user preferably accesses the system 10 by typing the system's Uniform Resource Locator (URL) into the appropriate section of the web browser. The user is then preferably presented with a home page or other information sent from the web server 20 to the client computer 22. This home page explains preliminary information about the use of the product design system to the user, and walks the user through the use of the design editor.

At the start of the design process, the user is preferably prompted by the web pages or web server 20 for some preliminary information about the product that the user desires to design (block 42). Because the present invention may be used to design a wide variety of products that may or may not be closely related to each other, the system 10 may prompt the user to “drill down” through a series of web pages, selections within a web page, or some other procedure to better determine the “overall” type and appearance of the product.

For example, a website for designing printed products may allow a user to customize stationary, business cards, signs, and/or stamps. The preliminary information requested by the server 20 may include: the type of product to be designed; the size, shape, and orientation of the product and the printed elements; the text and graphical elements used for the product; the colors of the text and graphics; and/or the general positioning of the text and graphics on the product.

This preliminary information is preferably presented to and received from the user in a conventional client-server relationship. For example, the server 20 may present the user with a web page showing graphical representations of the various possible choices of products to be designed, and the user may use a keyboard, mouse or other input or selection device to choose from the choices provided. As each choice is made by the user, the result is preferably sent to the server 20 for further calculation or product design update, and a new set of choices are preferably sent back to the user on the client computer 22.

After each selection is made, the server 20 may create a graphical representation of the product as currently designed and electronically send this representation to the user. This allows the user to view his or her design as a work in progress and more accurately make the appropriate design choices to reflect his or her desires.

After certain preliminary information has been accumulated from the user, the web server 20 or other computer preferably sends a design editor or DHTML editor to the user to complete the design and customization of the product (block 44). All or part of the editor (in the form of static jscript/javascript code) may already exist on the client computer 22 (from another designing session according to the browser cache settings on the client computer), and this previously sent editor may be used in the current session if the new preliminary information can be sent to the cached design editor, for example using the HTTP “get” command discussed below.

The DHTML (Dynamic Hypertext Markup Language) editor (the “editor”) may be used to compose and layout almost any type of textual and/or graphical information. It may be especially useful in laying out business cards, stamps, stationary, or other items in a “real-time,” interactive fashion. The editor preferably has a look-and-feel that corresponds to desktop applications that are familiar to most users. For example, the editor may utilize scrollable windows and drag-and-drop editing features.

In general, the editor is preferably comprised of two main sections: a preview pane where the current design of the customized product is graphically displayed for the user, and an element editor pane or window that allows the user to edit various elements or features of the designed product. The element editor may show a table of customizable elements along with a re-definable list of element characteristics. The preview pane and element editor may be shown on the same web page or on separate web pages. “Frames” or other multi-page web technologies may be used to split the user's browser working area into the two relevant sections. However, “frames” need not be used. As is the case with frames or non-frames, definable divisions known as “positioned layers” or “divs” may be used to split the working area into two or more relevant sections.

The editor is preferably used to edit, format, and position product design elements (text and/or images) within a predefined area of the user's web browser window in an absolute or relative (X, Y) position. Each element of the product design is preferably separately “encapsulated” in its own logical element block or layer that contains not only the content of the image or text, but also has an accompanying web script or other information carrier that defines aspects, characteristics, or features of the element. For example, a block of text may have a certain content, e.g., “your name,” but may also have an associated script that defines the size, font, justification, and/or absolute or relative X, Y positioning of the text in the area of the browser screen defined by the image of the user-designed product. By attaching these scripts to the elements, a more comprehensive and accurate editing procedure may be implemented. Furthermore, by defining containment or encapsulation of certain elements within a logical block, parent-child relationships are formed and enforced by the attached scripts. This allows attribute definition such as width, alignment, and color to be inherited by encapsulated elements.

The editor is preferably coded using a variety of different computer languages and functionalities. For example, the editor may be a combination of Server-Side Java, Client-Side JavaScript (sometimes referred to as Jscript), CSS (Cascading Style Sheets), DHTML Layers, and HTML (Hypertext Markup Language). The Server-Side code may be written in a variety of other languages in addition to or in place of Java.

The elements of the designed product may include a piece of text and/or a graphic logo. The text and logo were preferably chosen as part of the preliminary design process (block 42) described above. The text and logo may be transferred from the web server 20 or other computer to the design editor at the client computer 22. For example, the HTTP “get” and “post” commands can be used to transfer variable information via the Internet 24. The design elements are preferably defined according to the size, type, and location of those same elements in a sample template chosen by the user as part of the preliminary element selection.

As the design editor receives the HTTP “post” or “get” variables or other information, the editor preferably creates a separate “design element” that includes the content of the text or image as well as a referenced or associated script describing the location and characteristics of that element. For example, the designed product could be divided into “layers” according the HTML “div” tag. Each element can then be separately identified (as a “block” or “layer”) and scripted. The elements themselves exist according to the HTML tag and the substance and style of the element (formatting, location, etc.) can be scripted in JavaScript or some other language. Likewise, Cascading Style Sheets (CSS) could be used in much the same way.

One aspect of dividing the product into elements may enable each element to be “dragged” around the user's screen. For example, the “div” tag and associated script can enable the user to move the mouse or other pointing device over the design element on the screen and depress a mouse button (“click” the mouse) to select the element. If the mouse is moved while the mouse button is depressed, the element will be moved around the screen while other elements remain static. The element may even be moved off the screen (outside the bounds of the designed product). Standard JavaScript events play a large role in handling drag and drop mouse action. These events include onMouseDown, onMouseUp, onMouseOut, and others. These events trigger a custom coded decision process that determines when to drag/drop an element or select it for editing.

While the user drags the element around, the underlying scripting can preferably track the mouse cursor movement and calculate a new absolute or relative position for the element (based on how far the mouse “dragged” the element. When the element is in the proper position on the product design, the user may release the depressed mouse button to “drop” the element in its new position. Preferably, all elements of the product design can be dragged-and-dropped.

The different design elements may be selected, dragged, dropped, edited, or otherwise manipulated by the editor depending on the application. For example, the textual elements of the design may allow formatting including bold, italic, alignment or justification, foreground and background color, size, font, and the content of each specific word or message. The image, logo, or graphical elements of the product design may allow reformatting of the color, size, or other aspects of the design. The position of any of these elements in the design is also preferably adjustable by the user using simple drag-and-drop technology.

Because of the accurate absolute/relative positioning of the X, Y location of each element, the formatting and positioning of each element within the editor (on the user's screen) preferably accurately represents in WYSIWYG (What You See Is What You Get) fashion nearly exactly what the final product or press image will look like. This “exact” positioning is captured from a scripted property of a block, layer, or other element ID which reads the exact X, Y position of the upper left corner (or some other position) of the block.

This design editor preferably works in conjunction with available and widely distributed web browsers such as MICROSOFT EXPLORER. The editor may also be incorporated into various proprietary or individually written programs to be used as part of a website or other functionality.

In order to keep selected blocks or elements in a certain position, there may also be a logical “toggle” or switch that allows the user to define a block or element as “immovable” by the design editor. For example, a human resources person at a company may create an “overall” design or template for a business card, to be used by several members of the company to create their own personal business cards. Although each individual user may be allowed to add various personal information depending on their preferences (cellular phone number, fax number, email address, etc.), the company may wish for the overall look-and-feel of the business cards to be similar. Therefore, the company logo size, color, and orientation may not be re-definable or movable in the editor by a subsequent user. Such a system may allow an increased amount of user customization while still maintaining some modicum of corporate control or consistency.

After the user has used the element editor to modify the various table entries of the designed product, the user preferably sends the product design information to a PDF rendering engine or rendering computer (block 48) capable of taking the information and creating a PDF file (block 50) that defines the graphical representation of the product. Because the product design information resides as a characteristic name (such as “font”) and associated value (such as “courier”), these name-value pairs may be sent to the PDF rendering engine together. For example, the HTML “get” and “post” commands may be used to transfer name-value pairs (e.g., font=courier) to the PDF engine 26, web server 20 or other computer which allows the PDF engine to manipulate the data. There may be 100 or more name-value pairs associated with a given product design.

The name value pairs are preferably received by the web server 20 or other computer and sent to a database structured to accept the various name-value pairs. The database may then be analyzed at the web server 20 or a separate PDF rendering computer 26 by a software program that is able to convert the name value pairs into a corresponding PDF file.

The PDF document format may be a preferred format for the invention because it makes a very high quality image (as opposed to a conventional bitmap) that may be suitable for sending directly to a printing press or other manufacturing equipment 30. Other common data formats may be used, or a proprietary format could be developed within the scope of this invention. However, the PDF format is preferred because there is existing printing and other manufacturing equipment 30 currently capable of accepting the PDF format.

The PDF (Portable Document Format) rendering engine 26 (“the engine”) takes the paired data and preferably creates a multi-color, multi-page PDF using almost exact pixel positioning of the text and image elements as designed and placed by the user using the DHTML editor. Preferably, the resulting PDF is color-separated so that the PDF can be sent directly to a printing press or other device 30 that creates a colored product by adding one color at a time.

The PDF rendering engine 26 may be written within an ASP (Active Server Pages) framework using VBScript (Visual Basic Script), ADO (ActiveX Data Objects), SQL (Structure Query Language), HTML (Hypertext Markup Language), and ActiveX API calls to PDF library files that are generally available. Alternatively or additionally, a version of the PDF rendering engine 26 may be coded in Java.

As described above, the engine 26 may be called directly from the editor, for example, when the user selects to either “proof” or “order” their design. The relevant design description values are preferably posted (e.g., using HTTP “Post” command) to the engine 26 as name-value pairs. The capturing and posting of these values may be a part of the engine process itself, or they may be captured by the web server 20 and or other computer and then sent to the rendering engine 26 in some separate or integrated process, for example from an intermediate database.

Some examples of name-value pairs that may be used by the PDF rendering engine 26 to produce a PDF that describes a multi-color printed product (e.g., a business card, stationary, or notepad) may include: template size; background color; block dimensions and position (in X, Y absolute or relative terms); text elements within a block including color, contents, alignment and/or font; and image elements within a block including scaling (e.g., 0-200%) and contents (relative or actual path to an image file).

The engine process (block 50) preferably begins once the above (or other) values are posted to the rendering engine 26. The PDF rendering process may begin with the generation of a random number that is used to identify the user session and may be used to at least partially identify the resulting PDF file. This number, known as a GUID (globally unique identifier), may help identify a later relevant engine session to the current session.

The received “posted” values are preferably parsed from the name-value pairs and inserted into a database table using a two-step logical process. Once inserted, a one-to-many relationship between blocks and their contained elements may be created using SQL. Once this relationship is created and “posted” data is saved to the database, this information may be used at a later time to either recreate the editor state exactly (thus creating a new editor session from saved work), or to generate/regenerate a PDF file.

A PDF file may be opened and initialized as an ActiveX object using one of several commonly available PDF libraries that can be licensed from various sources. The text and image blocks are preferably examined and added to the initialized PDF file by a proprietary software algorithm. For example, the software may first search for all blocks that contain logos or other image files. These graphical files may be embedded in or added to the PDF file in the “exact” X, Y position that the user placed them in the editor. Scaling may be applied to the logo in a proportional pixel resize method. If the logo is in a vector format (e.g., PDF, EPS, WMF), scaling may be applied by vector coordinate transformations. This method results in the highest possible quality of resizing and may be used for all stock logos available. This “real-time” scaling may be advantageous compared to conventional design engine methodologies because users will often have logos that are not of the appropriate size for the intended use. Also, any mask (such as transparencies in GIFs or PNGs) may be preserved by the PDF engine. Preferable image formats for use with the PDF engine may be JPG, PNG, GIF, PDF, EPS and TIFF. Because of image conversion technologies employed, almost any image format is supported because it can be converted to a preferred format.

After the image blocks or image elements are inserted into the PDF, the text blocks are preferably examined and inserted into the PDF at the “exact” position where they were placed in the editor. The fonts chosen by the user in the design editor may be used on a per line basis. The font is preferably embedded in the PDF using a binary Type 1 font file installed on the web server 20. Using batch font conversion techniques, virtually any font made available for licensing (or custom fonts) may be used by the PDF rendering engine 20. Preferably, the engine 28 does not rely on the fonts used in the editor, and only the name of the font passed as a value to the engine 28 limits the available fonts.

During this phase of the rendering process, color may be passed as RGB and the appropriate color (found by performing a hexadecimal to binary conversion) may be used for the text. Alignment (e.g., left, right, center) may be performed on a per line basis within each block. Proper X, Y positioning for non-default aligned text lines may be found by using custom arithmetic and logic involving block width, font type and size, and text content of each line per block.

All blocks containing lines (horizontal or vertical) are preferably examined and drawn in the “exact” X, Y position that the user placed them in the editor. The process is much the same as the logo embedding process, except that scaling may not be supported. Multiple colors and adjustable line thicknesses are preferably supported.

At this stage, the PDF file is now built in single page composite (non-color-separated) form. This single page composite may be sent to the user for inspection and acceptance (block 52). If the user approves and the product is to be printed, the PDF may be color separated and released (block 54) to a manufacturing computer 28. Another software program (or the same program) may be used to create a new page for each printing plate color. For example, a red and process blue card with a multi-color custom logo may need three plates.

Each page may then be used to create a printing plate for actually printing or otherwise manufacturing a custom designed product. These printing plates are preferably created directly using the PDF for maximum accuracy. The printing plates can then be inserted into a machine for printing the final product.

If multiple products of various colors are run on a single machine, it may be preferable to batch the jobs according to color. For example, all plates to be printed in one specific shade of blue may be batched together and run on the machine consecutively. Hence, the color being run on the machine may only need to be changed a minimal number of times. This may result in a more efficient workplace.

As described above, a traditional design editor may allow a user to input or select different information, such as text and/or pictures, to design a custom-made printed product. The exact appearance of the final product ensuing from these traditional design methodologies may be largely unknown because the look of the designed product on the design web page may not be completely accurate. Also, the user may have a limited amount of options when attempting to edit the design or reposition the elements of the design. The present invention may partially alleviate one or more of these problems.

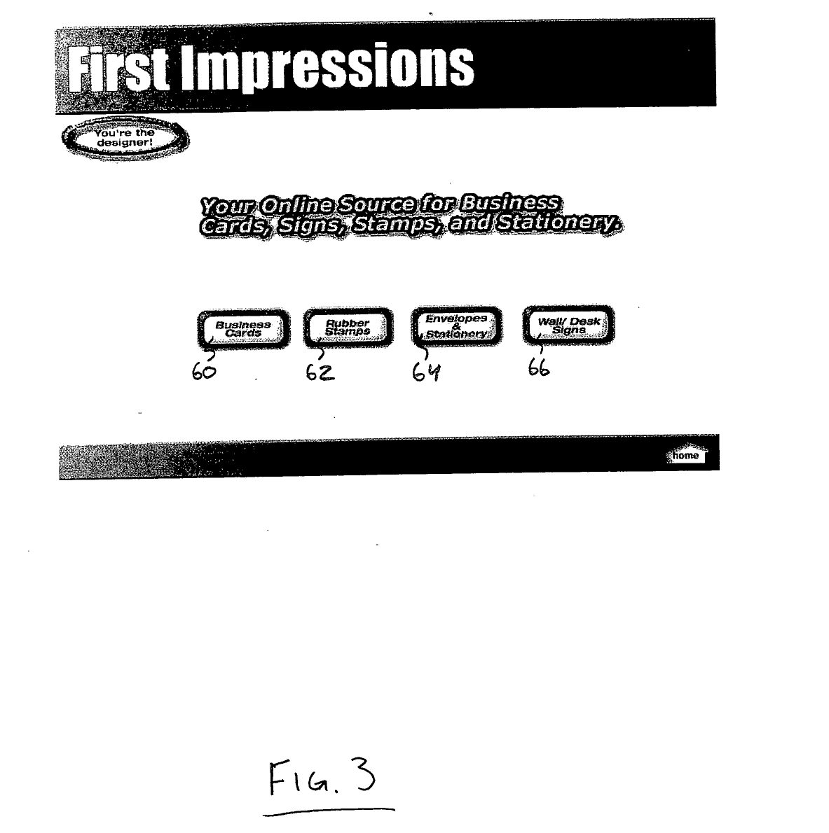

The above explanation described the present invention in general terms without describing the design of any product in particular. The following example describes the generation of a custom-designed business card using one embodiment of the design system of the present invention. After inputting the appropriate URL into a web browser, the user is preferably presented with a web design site home page or other page that introduces the top level design choices. As shown in FIG. 3, this exemplary site includes capabilities to design business cards 60, rubber stamps 62, envelopes and stationary 64, and wall/desk signs 66. Because each of these products have different preliminary design choices that may be made before using the DHTML editor, this preliminary design stage is preferably segregated for each product type.

Using a computer mouse, keyboard, or some other input or selection device, the user preferably selects the “business card” button or graphic 60. An indication of the selection may be sent electronically from the user (client) computer over the Internet or other computer network to the server. The server may recognize the selection and send the next appropriate web page to the user.

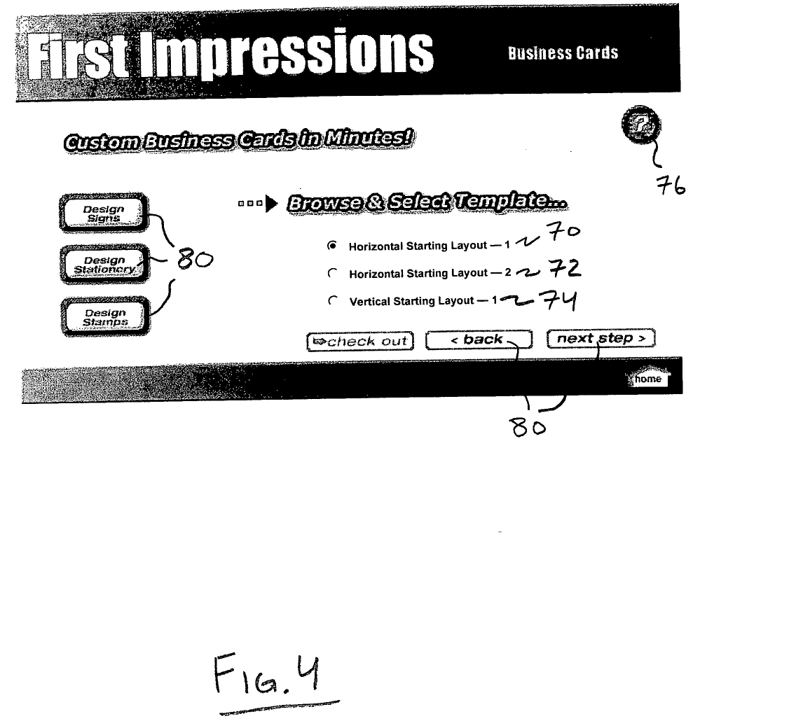

This next page, shown in FIG. 4, preferably details the next preliminary choice or choices to be made by the user. Here, the starting layout for the business card can be selected from the choices of horizontal 1 70, horizontal 2 72, and vertical 1 74. It should also be noted that there is a “?” button 76 that may be linked to a “help” web page, navigational buttons 78 to move through the series of preliminary selections, and other selectable buttons 80 with various functionality to guide the user through the design process. An indication of the selection of one of these choices, for example “horizontal 1 70,” is preferably sent electronically from the client to the server where a calculation or other decision may be made to determine the next appropriate web page to send to the user.

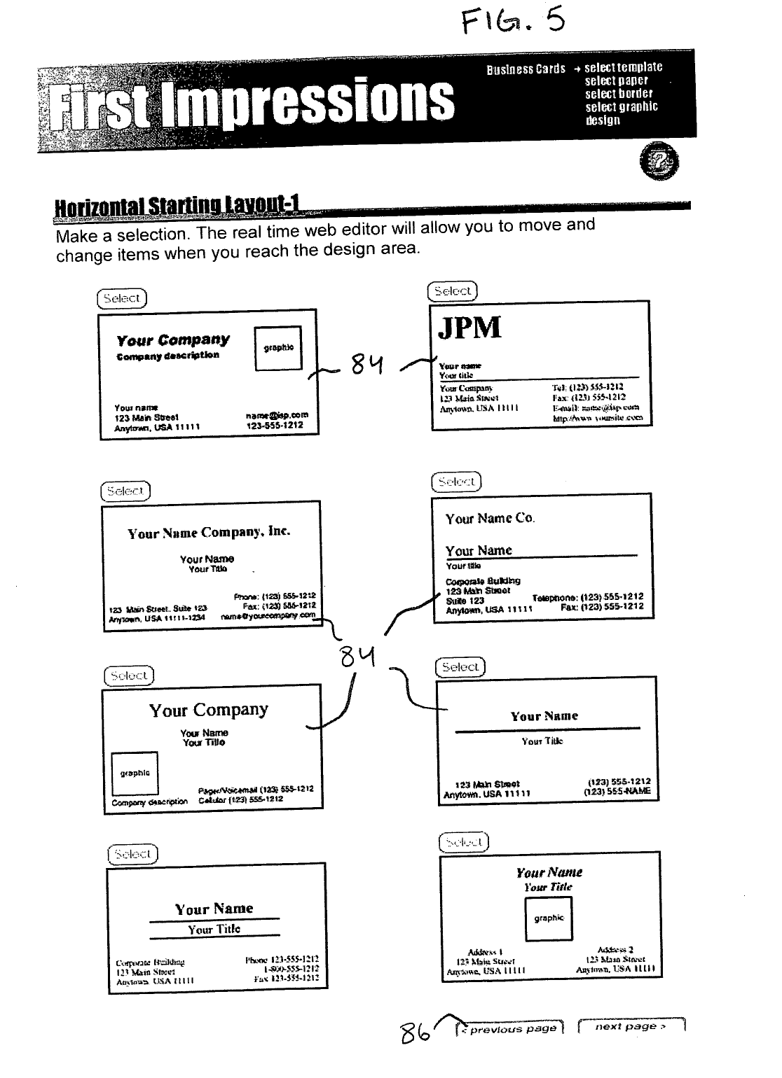

FIG. 5 shows a sample third page in the present business card design system wherein various choices or templates of different horizontal business cards are presented to the user 84. The user preferably selects the template 84 that most nearly represents the user's desired business card. If none of the templates 84 are sufficiently close, the user may select to jump back 86 to a different group of templates, or the user may choose to start the entire process over. If one of the template layouts 84 is close to the user's desired business card, the user preferably selects the appropriate template 84 with the mouse, keyboard, or other selection device. An indication of this selection is preferably sent back to the server for processing.

At every stage of this preliminary design selection, the client and server may interact with each other. Every time this interaction occurs, there may be an associated time lapse and possibility for data loss or error. For example, these interactions are limited by the amount of Internet traffic both through the user's Internet Server Provider (ISP) and through the server. Also, the client or the server computers may experience communication problems during the session. If there is a great distance between the client and server computers, there will be some inherent delay in the communications.

Every data exchange between the computers introduces the possibility that corrupted or other non-desired data is introduced into one of the applicable computer systems. Traditional design systems often perform not only preliminary tasks, but all tasks based on this client-server communication model. In the present system, although the preliminary decisions are made using client-server communications, this interaction is minimized after these few preliminary decisions are made.

After the server receives the template choice, the server may further prompt the user to select certain attributes of the desired business card. For example, the paper on which the cards are to be printed may be selected from various colors, textures, and materials of paper. The system may enable the user to select the color, size, and design of a border to create a decorative outer region on the business cards.

One or more logos, pictures, or other graphics may be added to the business card (or other product) designed by the user. The server preferably has a library of common graphics for addition to the cards, and these graphics may be stored in various libraries according to subject matter. Additionally, the design system may enable the user to transfer a logo or other image to the business card from a file that currently exists on the client computer. Because the ultimate printing or manufacturing process is preferably computer-controlled, the design system may be adapted to accept a variety of different data and file types to be incorporated into the final product.

After all of the text and graphics are selected, and any other preliminary choices are made, the user may be prompted to start using the DHTML editor. As explained above, this editor preferably allows drag-and-drop repositioning and extensive editing capabilities without client-server interaction after every attribute is updated. When the user selects to use the editor, the server 20 preferably sends the complete relevant portions of the DHTML design editor to the client computer 22.

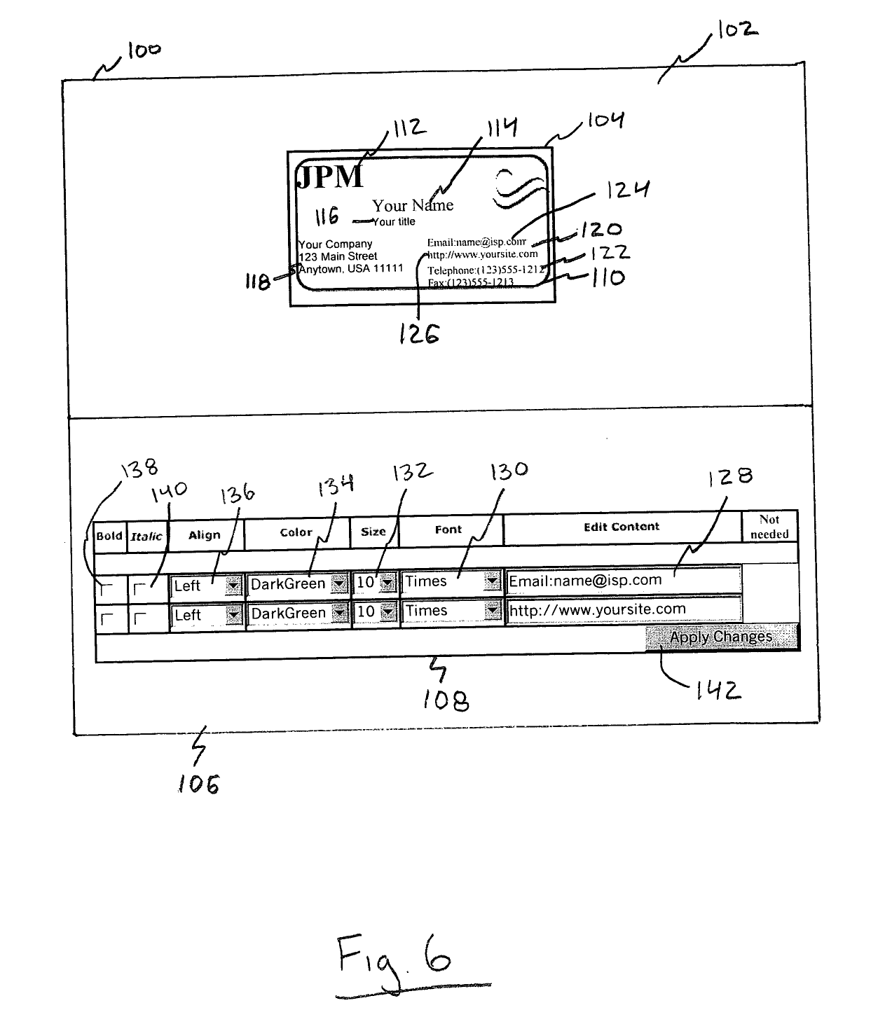

As seen in FIG. 6, the editor may appear to the user as a two-paned window 100 including a first pane 102 showing a designed product sample 104 and a second pane 106 showing an associated table of editing information (element editing area) 108. In our example, there is a custom business card 104 at the top of the page and a table of editing features 108 at the bottom. Each element (text, graphic, or other) is preferably attached to a different block or layer and can be repositioned or edited independently. Because each layer has its own associated script defining location, size, color, and other characteristics, each element may be separately edited.

For example, the business card 104 of FIG. 6 includes: a border 110; a large set of initials 112; a name 114 and title 116; and various address 118, Internet 120, and telephone number 122 information. Using the mouse or other selecting device, the user can move the computer cursor over the element of the business card 104 which the user desires to edit. In FIG. 6, the user has moved the mouse cursor over or selected the area of the business card 104 including the email address 124 and company website 126. The lower part of the web page 106, or possibly a different page, will have an element editing area 108 where the highlighted or selected elements 124, 126 may be edited.

In the FIG. 6 example, the information block, layer, or element describing the email address 124 can be edited by content 128, font 130, font size 132, color 134, and/or alignment 136, and the text can be made either boldfaced 138 or italicized 140. Similar design attributes can be altered for the company website element 126 in the business card 104. The user may move the mouse or other pointing device down into the element editing area 108 and amend any of these features. The user will preferably first replace the sample text 128 (content) with his or her own text for the business card. The user may also elect to change some other attribute of the text.

Preferably, at any time during this editing process, the user may also bring the mouse pointer or other device up into the business card display area and “drag-and-drop” one or more design elements into a new position on the business card 104. For example, the user may wish to move the name block 114 up to the top of the card 104, or the user may wish to reorder the address 118 and telephone number 122 information. This repositioning preferably takes place immediately and occurs by “holding down” a mouse button while moving the element into its new position according to well-known mouse techniques.

The changes that the user makes to the size, font, and other attributes of the text and graphics in the element editing area may take effect immediately upon entering the changes, or the element editing area 108 may have an “Apply Changes” 142 or other selectable button (shown in FIG. 5) that causes the changes to take effect after one or more changes have been entered into the element editing area 108. A change preferably “takes effect” by altering the look of the business card 104 in the preview pane 102 or business card area of the design editor. Preferably, the changes take place in the underlying Java Script or other code at the client computer 22 (by updating the applicable scripts), without the need for any additional interaction with the server 20.

If the user wishes to change a different design element of the business card 104, the user may move the mouse pointer or other device over the appropriate new element in the business card 104. For example, if the user selected the business card logo, the element editing table may change to present the user with various attributes (size, color, type, etc.) for altering the look of the logo on the business card 104.

Once the business card 104 in the preview pane 102 matches the desired business card, the user preferably can preview 142 a large version of the card as a PDF file detailing exactly what the printed business card should look like when manufactured. Upon selecting to preview the PDF, the edited business card content information is preferably sent from the design editor at the client computer 22 to a PDF rendering engine 26 either on the web server 20 or at some other location. As explained above, the information is sent in name-value pair format.

The PDF rendering engine 26 preferably uses a software program to create a PDF file based on the business card information as edited in the DHTML editor. The PDF file may then be sent back to the client computer 22 so that the client can view the final PDF version of the business card (e.g., using ADOBE ACROBAT READER). If the business card is not acceptable at this point, the DHTML editor may be reloaded, and the business card may be re-edited. After re-editing, a new PDF file, including the updated information, is preferably created at the PDF rendering engine and sent to the client computer for approval.

If the business card 104 is acceptable at this point, the user may order some number of business cards by various payment methods. Preferably, there is a web-based form that the user fills out including quantity, shipping information, price, and/or special handling instructions. When the user fills out the form and accepts it, the information in the form is preferably sent to a billing or other computer that releases the PDF file to the manufacturing or printing machines 30. Because the PDF file already exists at the PDF rendering engine 26, there is no need to send the PDF from the client computer 22 back to the rendering computer 26 at this point in time. Preferably, a much smaller message with shipping and billing information can be sent.

The web server 20, PDF rendering engine computer 26, billing computer (not shown), and manufacturing computer 28, may all exist at one location (they may even be one computer) or they may be distributed across various locations. For example, one PDF rendering engine computer 28 could be used by several different manufacturing organizations.

Once the PDF file is released to the manufacturing computer 28, that manufacturing computer is able to use the PDF file to print the business card 104. Preferably, the software that runs the manufacturing and/or printing equipment 30 can be directly driven with the PDF file so that the actual printed business card looks almost exactly like the PDF file that the user viewed on their computer 22. By using the PDF file itself to run the printer 30, the business card will more closely resemble the user's design than by conventional methods. In the present example, the PDF file may be used to automatically create various color-segmented printing plates that are used to print the business cards.

Once the printing run is complete, the business cards may be shipped to the user according to the shipping information that was sent with the order. The business card information may be saved either on the client computer 22 or one of the other computers for later use. The user may also start a new design session (e.g., for a stamp, stationary, envelope, or another business card) at this time.

Although the above example related to business card creation and the above discussion talked about conventional printing applications, the present invention could also be used to created other customized products such as T-shirts, coffee mugs, and other promotional items. Any black and white or colored application where independent manipulation and editing of constituent elements may be created using this invention.

The technology of the design editor may also be used in other applications besides uses associated with the printing industry. For example, this technology may be used to change and capture positions of information blocks for the personalization of WWW (World Wide Web) portal or other personal home page. Traditional “personal home pages” may allow a user to select or adjust certain page attributes or content information in creating a personal home page for a web portal, auction site, or some other web-based information page.

Using the technology of the present invention, a design editor may allow a user to drag-and-drop elements of a personal home page to any location on the screen. The absolute or relative X, Y positioning incorporated in the design editor may allow a much more customizable personal home page experience than conventional methods. Rather than simply selecting from a predefined set of choices, the user may now create a home page according to their own specifications.

This may be especially useful when creating a general portal to the Internet based on the tastes of the user. A traditional personal portal builder may allow the user to select an absolute position of the screen for sports scores, stock updates, news, or any other information. The present invention may allow absolute and accurate positioning of porthole information in a drag-&-drop format with little client-server interaction. Furthermore, because of the WYSIWYG aspect, portal pages need not be limited to a traditional 800 pixel screen width. A user may choose to place a sports block at the far right edge of their window, whose position varies by screen and monitor size.

The above specification describes several different embodiments and features of a system and method for creating a custom-designed product. Various parts, selections, and/or alternatives from the various embodiments may preferably be interchanged with other parts of different embodiments. Although the invention has been described above in terms of particular embodiments, one of ordinary skill in the art, in light of the teachings herein, can generate additional embodiments and modifications without departing from the spirit of, or exceeding the scope of, the claimed invention. Accordingly, it is to be understood that the drawings and the descriptions herein are proffered by way of example only to facilitate comprehension of the invention and should not be construed to limit the scope thereof.

What is claimed is:

1. A design system, comprised of:
a web server;
a client computer; and
a PDF rendering engine for automatically generating a PDF based on a desired product designed at the client computer, wherein said server, said computer, and said engine are in communication with each other.

2. The design system of claim 1, further comprised of:
a database associated with said PDF rendering engine.

3. The design system of claim 2, wherein said PDF rendering engine is capable of accepting information about said desired product from said client computer in the form of name-value pairs.

4. The design system of claim 1, further comprised of:
a manufacturing computer capable of receiving said PDF; and
a manufacturing device in communication with said manufacturing computer capable of producing the desired product based on the PDF.

5. The design system of claim 1, further comprised of:
a web-based design editor that allows a user to redefine attributes of the desired product.

6. The design system of claim 5, wherein said attributes include text elements and graphical elements.

7. A method for designing a product, comprising the steps of:
providing to a user at least one web page including selectable preliminary choices about the product;
receiving an indicator of said preliminary design choices from the user;
providing a web-based design editor to said user;
receiving name-value pairs of information describing at least one attribute of said product; and
generating a PDF based on said preliminary design choices and said name-value pairs.

8. The method of claim 7, further comprising the step of:
releasing said PDF to a manufacturing computer after the user approves the PDF.

9. The method of claim 7, wherein said web-based design editor is provided to the user from a memory cache on a computer at the user's location.

10. The method of claim 7, wherein said web-based design editor is provided to the user from a web server remote from the user.

11. The method of claim 7, wherein said web-based design editor allows the user to relocate attributes of said product using drag & drop mouse functionality.

12. The method of claim 7, wherein said name-value pairs are incorporated into a computer program script.

13. A software-based design editor, comprised of:
data on a computer readable medium capable of displaying a graphical representation of a product, wherein said graphical representation of the product is comprised of at least one independent design element; and
data on a computer readable medium capable of displaying a table of editing information, wherein said table of editing information includes customizable attributes of a user selected independent design element, wherein a user selects said user selected independent design element from the graphical representation of the product.

14. The software-based design editor of claim 13, wherein said graphical representation of the product and said table are displayed in two separate screen windows.

15. The software-based design editor of claim 13, wherein the user selected independent design element in said table is selected by the user using a computer mouse.

16. The software-based design editor of claim 13, wherein the location of each of said at least one independent design elements can be changed by dragging each of said elements in the graphical representation of the product using a computer mouse.

17. The software-based design editor of claim 13, wherein the customizable attributes of a user selected independent design element can be changed by the user by editing the information in said table.

18. A method of relocating elements of an electronic display, comprising the steps of:
providing an image of the electronic display including at least one independent design element to a user;
enabling the user to redefine attributes of said at least one independent design element;
defining name-value pairs of information describing said user redefined attributes of said at least one design element; and
updating the electronic display based on said name-value pairs.

19. The method of claim 18, wherein said enabling step includes enabling a user to drag & drop with a computer mouse said at least one independent design element to a new location in the electronic display.

20. The method of claim 18, wherein said electronic display represents an Internet portal website.
